(19) United States
(12) Patent Application Publication
(10) Pub. No.: US 2026/0183187 A1
(43) Pub. Date: Jul. 2, 2026

(54) MASSAGE POOL

(71) Applicant: BESTWAY INFLATABLES & MATERIAL CORP., Shanghai (CN)

(72) Inventors: Xianglin ZENG, Shanghai (CN); Chenggen LIU, Shanghai (CN)

(21) Appl. No.: 19/290,644

(22) Filed: Aug. 5, 2025

(30) Foreign Application Priority Data
Jan. 2, 2025 (CN) 202520007173.X

(51) Int. Cl. A61H 33/00

(52) U.S. Cl. CPC A61H 33/0087; A61H 33/6005; A61H 33/6047

(57) ABSTRACT

A massage pool includes an inner wall, an outer wall, an upper wall, a bottom wall, a water cavity defined by the inner wall and the bottom wall, a massage assembly provided in the water cavity and configured to spray a water flow into the water cavity, the massage assembly including a shell located in the water cavity and defining an accommodating space together with the inner wall, a spray head assembly located in the accommodating space and detachably connected to the shell, a water flow pipeline connected to the spray head assembly that provides a water flow to the spray head assembly, and a water pump located outside the water cavity and connected to the water flow pipeline.

### CROSS-REFERENCE TO RELATED APPLICATIONS

The present disclosure claims priority to Chinese Patent Application No. 20250007173.X, filed with the China National Intellectual Property Administration on Jan. 2, 2025, and entitled “MASSAGE POOL”, which may be incorporated herein by reference in its entirety.

### TECHNICAL FIELD

The present disclosure relates to the technical field of above-ground pools, and in particular, to a massage pool.

### BACKGROUND

A massage pool may be generally used for physical therapy, relaxation and leisure. Traditional massage pools often include a side wall, a bottom wall, and a water cavity for containing water formed between an inner wall of the side wall and the bottom wall. These massage pools may also include spray head assemblies that are arranged on the inner wall of the massage pool, and a fluid pipeline that is connected to the spray assemblies and to a water pump. Accordingly, in traditional massage pools, the water pump provides power, and the spray head assemblies spray water or a water-air mixture into the water cavity for massage purposes.

However, spray head assemblies of traditional massage pools are often welded to the inner wall, which may make it difficult for a user to inspect the spray head assemblies for faults or other damage that may prevent the spray head assemblies from operating as intended. This issue is particularly prevalent in inflatable massage pools, as damage to the spray head assemblies positioned within a sidewall of the inflatable my inhibit operation of the entire inflatable massage pool itself.

### SUMMARY

An objective of the present disclosure is to solve the problem that it is inconvenient to check a conventional massage pool and to repair a fluid pipeline of the pool. The present disclosure provides a massage pool, which can effectively solve the problem that it is inconvenient to check the conventional massage pool and to repair the fluid pipeline of the pool.

In order to solve the above technical problem, an implementation of the present disclosure discloses a massage pool. The massage pool includes: an inner wall including a top end and a bottom end; an outer wall surrounding the inner wall and including a top end and a bottom end; an upper wall connected to the top end of the inner wall and the top end of the outer wall; a bottom wall connected to the bottom end of the inner wall and the bottom end of the outer wall; a water cavity defined by the inner wall and the bottom wall; a massage assembly provided in the water cavity and configured to spray a water flow into the water cavity, the massage assembly including: a shell located in the water cavity and defining an accommodating space together with the inner wall; a spray head assembly at least partially located in the accommodating space and detachably connected to the shell; a water flow pipeline connected to the spray head assembly and configured to provide a water flow to the spray head assembly; and a water pump located outside the water cavity and connected to the water flow pipeline.

With the above-described technical solution, by arranging the massage assembly of the massage pool in the water cavity, a user can find water leakage of the water flow pipeline in a timely manner. Also, since the massage assembly is located in the water cavity, it is convenient to repair.

In some embodiments, the spray head assembly includes: a connecting portion in fluid communication with the water flow pipeline; a spray head at least partially located in the accommodating space and in fluid communication with the connecting portion; and a fixing member detachably connected to the connecting portion and clamping the shell together with the connecting portion.

With the above-described technical solution, it is convenient for the user to remove the spray head assembly for the repair or replacement of the spray head assembly by detachably clamping the shell with the fixing member and the connecting portion.

In some embodiments, the shell includes: a connecting hole accommodating at least part of the fixing member; and an inner side piece located in the connecting hole and connected to a hole wall of the connecting hole, the connecting portion and the fixing member clamping the inner side piece.

In some embodiments, the shell is located at a joint of the inner wall and the bottom wall, and the connecting hole of the shell is located in a top surface of the shell.

In some embodiments, an edge of the shell facing the inner wall and/or the bottom wall is coated with an elastic plastic.

With the above-described technical solution, a side edge of the shell is coated with the elastic plastic, which can effectively prevent the shell from scratching the inner wall or the bottom wall and then cause air leakage of an inflatable chamber of the massage pool, and effectively prolongs the service life of the massage pool.

In some embodiments, the massage pool further includes an air pipe, the air pipe including: a first end connected to the outer wall or the upper wall and in communication with the outside; and a second end in fluid communication with the connecting portion.

With the above-described technical solution, the massage assembly is provided with the air pipe, one end of the air pipe is connected to the spray head assembly, and the other end is connected to the inner wall or outer wall to allow the communication between the air pipe and outside air, the air pipe leads the outside air to the spray head assembly such that the outside air and the water flow form a water-air fixed fluid, the spray head assembly sprays the water-air fixed fluid into the water cavity to massage the user in the water cavity, and the water-air mixed fluid can provide better experience to the user.

In some embodiments, the water flow pipeline is located in the water cavity.

In some embodiments, the water pump is connected to the water flow pipeline by means of a water inflow pipe, the water inflow pipe including: a first end connected to the water flow pipeline; and a second end connected to the water pump.

In some embodiments, the water pump is provided outside the outer wall; the inner wall includes a first opening, the water inflow pipe passing through the first opening and being connected to the inner wall at the first opening; and the outer wall includes a second opening, the water inflow pipe passing through the second opening and being connected to the inner wall at the second opening.

In some embodiments, the water pump is provided outside the outer wall; and the inner wall includes a first opening, the outer wall includes a second opening, and a sleeve is arranged between the first opening and the second opening, the sleeve including: a first end connected to the inner wall; and a second end connected to the outer wall; where the water inflow pipe passes through the sleeve and is hermetically connected to the inner wall, the sleeve or the outer wall.

With the above-described technical solution, a sleeve is arranged in the inflatable chamber, a first end of the sleeve is connected to the inner wall, a second end of the sleeve is connected to the outer wall, and the sleeve forms a channel for the water inflow pipe to pass through in the inflatable chamber. Therefore, when the water leakage occurs in the water inflow pipe, it is convenient for the user to remove the water inflow pipe for facilitating replacement or repair.

In some embodiments, the water pump is provided outside the outer wall; and the water inflow pipe or the water flow pipeline passes through the bottom wall and is hermetically connected to the bottom wall.

In some embodiments, the massage pool further includes: a fixing piece located in the water cavity, the fixing piece including: a first connecting edge connected to the bottom wall; a second connecting edge arranged opposite to the first connecting edge, and connected to the inner wall; and a fixing space defined by the fixing piece and the inner wall, the fixing space accommodating at least a part of the water flow pipeline.

With the above-described technical solution, the water flow pipeline is limited to the joint of the inner wall and the bottom wall by the fixing piece, and when the user uses the massage pool, the user's body is not in contact with the water flow pipeline located at the joint of the inner wall and the bottom wall. In other words, the water flow pipeline located at the joint of the inner wall and the bottom wall does not bring a foreign matter sensation to the user and gives the user better experience.

In some embodiments, the fixing piece further includes a first end and a second end; the first end of the fixing piece extends to one of two adjacent massage assemblies, and the second end of the fixing piece extends to the other of the two adjacent massage assemblies; or the first end of the fixing piece extends to one of the massage assemblies, and the second end of the fixing piece extends to a water inflow pipe.

With the above-described technical solution, the first end of the fixing piece extends to one of the two adjacent massage assemblies, and the second end extends to the other of the two adjacent massage assemblies; alternatively, the first end of the fixing piece extends to the massage assembly, and the second end of the fixing piece extends to the water inflow pipe. Thus, the fixing piece covers the water flow pipeline while the water flow pipeline is limited to the joint of the inner wall and the bottom wall by the fixing piece, so that the water flow pipeline can be prevented from being exposed in the water cavity, and the aesthetic appearance of the massage pool can be effectively improved.

In some embodiments,, the massage pool further includes: an inflatable chamber jointly defined by the inner wall, the outer wall, the upper wall and the bottom wall, and surrounding the water cavity; and a plurality of tensioning members provided in the inflatable chamber, one end of each of the plurality of tensioning members being connected to the inner wall, and the other end being connected to the outer wall.

According to another embodiment of the present disclosure, a massage pool includes an inflatable chamber defined by an inner wall, an outer wall, an upper wall, and a bottom wall; a water cavity defined by the inner wall and the outer wall of the inflatable chamber; a water pump arranged outside the inflatable chamber; a massage assembly provided within the water cavity; a water flow pipeline connected to the massage assembly and configured to deliver water to the massage assembly; a water inflow pipe connected between the water pump and the water flow pipeline; wherein the water inflow pipe passes through the bottom wall and is hermetically sealed to the bottom wall, such that at least a portion of the water inflow pipe is arranged outside the inflatable chamber.

In some embodiments, the water flow pipeline extends along a joint formed between the inner wall and the bottom wall.

In some embodiments, the water flow pipeline is fixed in position by at least one fixing piece arranged in the water cavity.

In some embodiments, the at least one fixing piece further comprises: a first connecting edge coupled to the inner wall; a second connecting edge coupled to the bottom wall; and a fixing space defined between the fixing piece, the inner wall, and the outer wall, the fixing space being configured to accommodate the water flow pipeline.

According to another embodiment of the present disclosure, a massage pool comprises: an inflatable chamber defined by an inner wall, an outer wall, an upper wall, and a bottom wall; a water cavity defined by the inner wall and the outer wall of the inflatable chamber; a massage assembly provided within the water cavity, the massage assembly comprising: a shell defining an accommodating space; a spray head assembly including a spray head and a connecting portion, the connecting portion being detachably connected to the shell and the spray head being detachably connected to the connecting portion; and a water flow pipeline connected to the connection portion and configured to deliver water to the spray head; and at least one fixing piece comprising a first connecting edge connected to the inner wall and a second connecting edge connected to the outer wall, the fixing piece defining a fixing space that receives at least a portion of the water flow pipeline; wherein the at least one fixing piece is detachably mounted to the inner wall and the bottom wall.

In some embodiments, the spray head is detachably connected to the connecting portion using a snap-fit interface.

### BRIEF DESCRIPTION OF THE DRAWINGS

Other features and advantages of the present disclosure will be understood from the following embodiments described in detail herein and with reference to the accompanying drawings, in which like reference numerals represent the same or similar components.

FIG. 1 shows a perspective view of a massage pool, according to one or more embodiments shown and described herein;

FIG. 2 shows a side sectional view of the massage pool of FIG. 1, according to one or more embodiments shown and described herein;

FIG. 3a shows a perspective view of a water flow pipeline of the massage pool of FIG. 1, according to one or more embodiments shown and described herein;

FIG. 3b shows a perspective view of another embodiment of a water flow pipeline of the massage pool of FIG. 1, according to one or more embodiments shown and described herein;

FIG. 4a shows a side sectional view of the massage pool of FIG. 1, according to one or more embodiments shown and described herein;

FIG. 4b shows a side sectional view of the massage pool of FIG. 1, according to one or more embodiments shown and described herein;

FIG. 4c shows a side sectional view of the massage pool of FIG. 1, according to one or more embodiments shown and described herein;

FIG. 5 shows a perspective view of another embodiment of a massage pool, according to one or more embodiments shown and described herein;

FIG. 6 shows a schematic side view of a fixing piece of the massage pool of FIG. 5, according to one or more embodiments shown and described herein;

FIG. 7 shows a perspective view of another embodiment of a massage pool, according to one or more embodiments shown and described herein;

FIG. 8 shows a perspective view of a massage assembly of the massage pool of FIG. 7, according to one or more embodiments shown and described herein;

FIG. 9 shows an exploded view of the massage assembly of FIG. 8, according to one or more embodiments shown and described herein;

FIG. 10 shows a top view of an inner side piece of a massage pool, according to one or more embodiments shown and described herein; and

FIG. 11 shows a top view of a fixing member of a massage pool, according to one or more embodiments shown and described herein.

### DETAILED DESCRIPTION

Embodiments of the present disclosure are illustrated below, and those skilled in the art may readily understand advantages and effects of the present disclosure from the content disclosed in the description. Although the description of the present disclosure will be introduced in conjunction with preferred embodiments, it does not mean that features of the present disclosure are limited to the implementations described herein. On the contrary, an objective of introducing the present disclosure in conjunction with the embodiments described herein is to encompass other options or modifications that may be extended on the basis of the claims of the present disclosure. The following description contains numerous specific details in order to provide deep understanding of the present disclosure. The present disclosure may also be implemented without these details. In addition, in order to avoid confusion of the present disclosure, some specific details will be omitted in the description. It should be noted that the embodiments and the features thereof in the present disclosure can be combined with each other without conflicts.

In the description of the present disclosure, it should be understood that orientation or position relationships indicated by terms such as “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, and “anticlockwise” are based on orientation or position relationships shown in the accompanying drawings and are merely for ease of description of the present disclosure and simplification of the description, rather than indicating or implying that the apparatuses or elements referred to must have a specific orientation or be constructed and operated in a specific orientation, and therefore cannot be construed as limiting the present disclosure.

In addition, terms “first”, “second”, etc. are merely for the purpose of description, and should not be construed as indicating or implying the relative importance or implicitly indicating the number of technical features indicated. Thus, the features defined with “first” and “second” may explicitly or implicitly include one or more features. In the description of the present disclosure, the meaning of “a plurality of” is two or more, unless specifically defined otherwise.

In the present disclosure, it should also be noted that the terms “arrange”, “connected”, and “connection” should be understood in a broad sense, unless otherwise explicitly specified and limited. For example, the connection may be a secured connection, a detachable connection, or an integral connection; or may be a mechanical connection or an electrical connection; or may be a direct connection, an indirect connection by means of an intermediate medium, or internal communication between two elements. For those of ordinary skill in the art, the specific meaning of the terms mentioned above in the embodiments should be understood in specific cases.

In the present disclosure, unless otherwise explicitly specified and defined, the first feature being “above” or “below” the second feature may include the first and second features being in direct contact, or may include the first and second features being not in direct contact but coming into contact through another feature between them. In addition, the first feature being “above”, “over”, and “on” the second feature includes the first feature being directly above and obliquely above the second feature, or simply means that the level of the first feature is higher than that of the second feature. The first feature being “below”, “beneath”, and “on underside of” the second feature includes the first feature being directly below and obliquely below the second feature, or simply means that the level of the first feature is less than that of the second feature.

In the description of the present disclosure, the meaning of “a plurality of” is two or more, unless specifically defined otherwise.

To make the objectives, technical solutions, and advantages of the present disclosure clearer, the technical solutions of the present disclosure will be clearly and completely described with reference to specific embodiments of the present disclosure and corresponding figures.

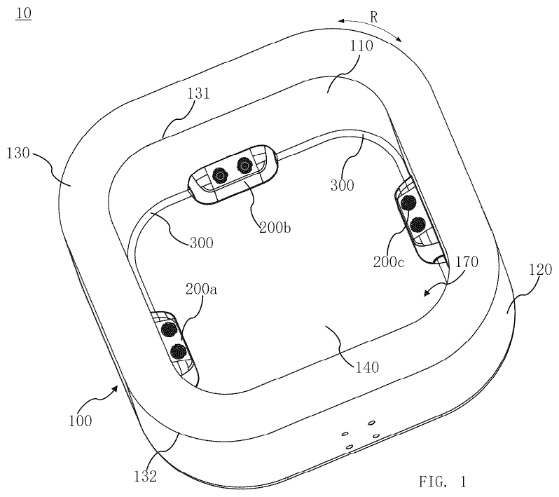

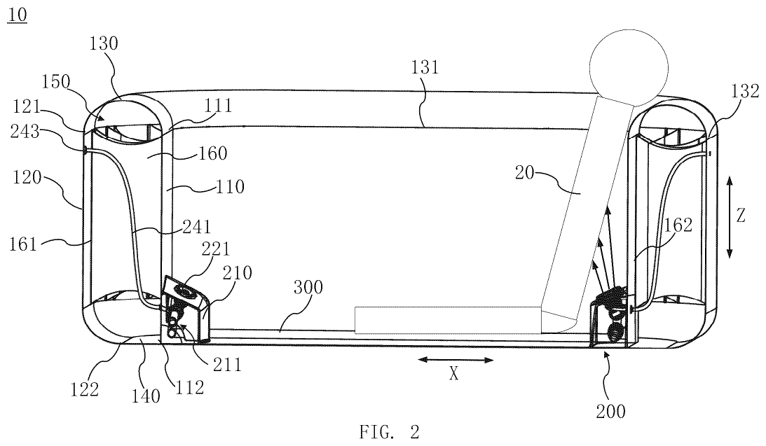

Referring now to the drawings, FIG. 1 shows a massage pool 10 according to an embodiment of the present disclosure, and FIG. 2 shows a sectional view of the massage pool 10 according to an embodiment of the present disclosure.

In the embodiments described herein, it should be appreciated that massage pools may be classified into fixed massage pools (e.g., a massage pool built with building materials such as tiles) and portable massage pools. The portable massage pools may be further classified into non-inflatable massage pools (e.g., a massage pool formed by splicing wood-plastic boards, foam blocks, etc.) and inflatable massage pools. The massage pool 10 in the embodiment of the present disclosure may be a fixed massage pool or a portable massage pool. For ease of description, the massage pool 10, which may be an inflatable massage pool in the portable massage pools, will be exemplified to illustrate the embodiment of the present disclosure.

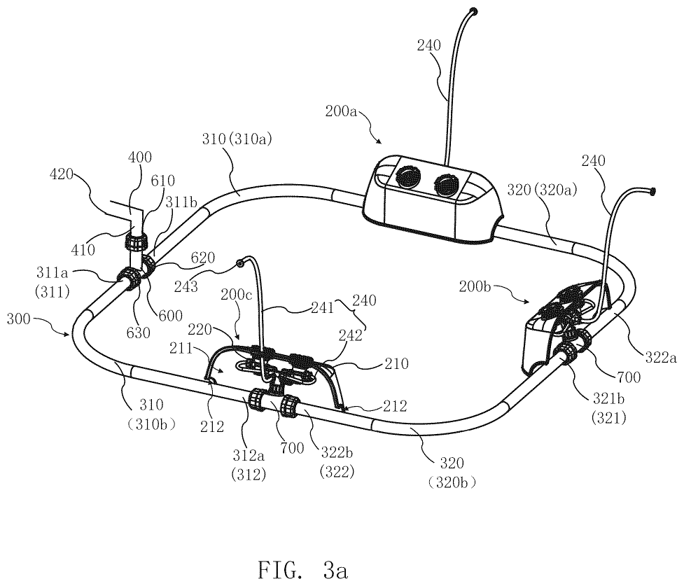

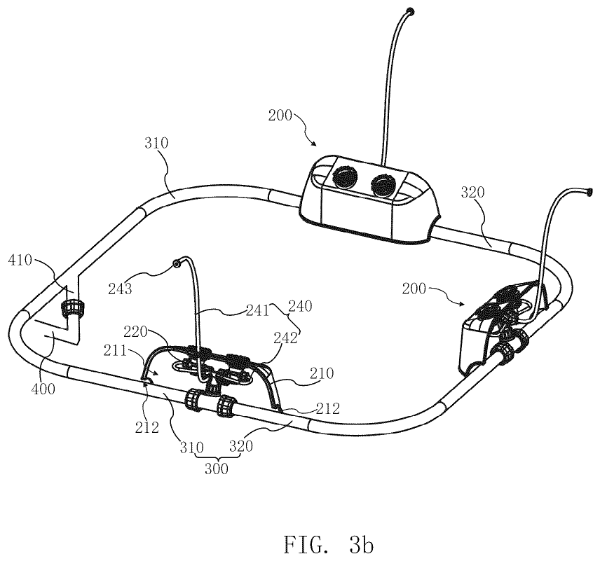

Referring to FIGS. 1 and 2, the massage pool 10 may include a pool body 100, a plurality of massage assemblies 200 (specifically a massage assembly 200a, a massage assembly 200b and a massage assembly 200c), a water flow pipeline 300, a water inflow pipe 400 (shown in FIG. 3a) and a water pump. The pool body 100 may be of a substantially rectangular structure from a top view and may further include a water cavity 170 that may be configured to contain water. In these embodiments, the water pump may be located outside the water cavity 170, the plurality of massage assemblies 200 and the water flow pipeline 300 may both be located in the water cavity 170, one end of the water inflow pipe 400 may be located in the water cavity 170, the water inflow pipe 400 may be connected to the water flow pipeline 300, and the other end of the water inflow pipe 400 may be connected to the water pump outside the water cavity 170. That is, the water pump may be connected to the water flow pipeline 300 by means of the water inflow pipe 400, and a joint of the water inflow pipe 400 and the water flow pipeline 300 may be located in the water cavity 170. When the massage pool 10 is used, the water inflow pipe 400 may provide a water flow to the water flow pipeline 300, the water flow pipeline 300 may provide the water flow to the massage assembly 200, and the massage assembly 200 may then eject (e.g., spray, etc. ,) the water flow into the water cavity 170 to massage a user 20 in the water cavity 170.

As depicted most clearly in FIG. 2, in order to engage massage assembly 200, the user 20 may lean against a side of the massage assembly 200 (e.g., in a horizontal direction X) such that the shoulder of the user 20 rests against the inner wall 110 or an upper wall 130, the back of the user and the inner wall 110 form an included angle (e.g., in a height direction Z), and the massage assembly 200 sprays the water flow or a water-air mixed fluid toward the back of the user (as indicated by the arrows in FIG. 2)to massage the back of the user 20.

As further depicted in FIGS. 1 and 2, the water flow pipeline 300 may be arranged in the water cavity 170, so that when the water flow pipeline 300 leaks, the user can find a water leakage point in time. For example, it should be appreciated that arranging the water flow pipeline 300 within the water cavity 170 (e.g., as opposed to within the side wall) may enable a user to visually and/or physically inspect the water flow pipeline 300 to identify a particular section of the water flow pipeline 300 that is leaking without having to disassemble and/or deflate any portion of the massage pool 10. To this extent, the repair difficulty of the water flow pipeline 300 may also be reduced, as a user may be able to access the water flow pipeline 300 using conventional tools without needing to unseal, puncture, or otherwise disturb the walls of the massage pool 10. Accordingly, it should be appreciated that the arrangement of the water flow pipeline 300 described herein may enhance the ability of the user to repair or replace the water flow pipeline 300.

Although the pool body 100 depicted in FIGS. 1 and 2 is generally rectangular in shape, it should be understood that the pool body 100 may take any shape without departing from the scope of the present disclosure. For example, in other possible implementations, the pool body 100 may also be circular, triangular, polygonal or the like from the top view.

Similarly, it should be appreciated that the number of the massage assemblies 200 is not specifically limited in the embodiments depicted in FIGS. 1 and 2. For example, although FIGS. 1 and 2 depict the pool body 100 as including three massage assemblies 200, the massage pool 10 may include any number of massage assemblies (e.g., one, two, four, five, etc.) without departing from the scope of the present disclosure.

Referring again FIGS. 1 and 2, in these embodiments, the pool body 100 may further include the inner wall 110, an outer wall 120, the upper wall 130, a bottom wall 140 and a plurality of tensioning members 160. The inner wall 110 and the outer wall 120 may be arranged opposite to each other. The inner wall 110 may include a top end 111 and a bottom end 112, and the outer wall 120 includes a top end 121 and a bottom end 122.

In these embodiments, the upper wall 130 may further include an inner edge 131 and an outer edge 132, where the inner edge 131 may be connected to the top end 111 of the inner wall 110 by means of welding or adhesion, and the outer edge 132 may be connected to the top end 121 of the outer wall 120 by means of welding or adhesion. As further depicted in FIGS. 1 and 2, the bottom wall 140 may be connected to the bottom end 112 of the inner wall 110 by means of welding or adhesion, and the bottom wall 140 may be connected to the bottom end 122 of the outer wall 120 by means of welding or adhesion. The inner wall 110, the outer wall 120, the upper wall 130 and the bottom wall 140 may jointly define an inflatable chamber 150 (also referred to as a chamber 150, which may be collectively referred to as the inflatable chamber 150 for ease of description). The water pump may be located outside the outer wall 120. Furthermore, although the various edges and walls described hereinabove may be connected via welding or adhesion, it should be appreciated that these embodiments are exemplary in nature, and the various walls and edges may be connected via any suitable coupling without departing from the scope of the present disclosure.

Referring now to FIG. 2, the plurality of tensioning members 160 may be arranged in the inflatable chamber 150, each tensioning member 160 of the plurality of tensioning members 160 may include a first end 161 and a second end 162, the first end 161 of each tensioning member 160 may be connected to the inner wall 110 by means of welding or adhesion, and the second end 162 may be connected to the outer wall 120 by means of welding or adhesion. After the inflatable chamber 150 may be inflated, each tensioning member 160 applies a tensile force to the inner wall 110 and the outer wall 120, thus allowing the massage pool 10 to be in a preset shape (i.e., the rectangular shape described above).

Although the plurality of tensioning members 160 are described hereinabove as being secured to the inner wall 110 via welding or adhesion, it should be appreciated that these embodiments are merely illustrative in nature and the plurality of tensioning members 160 may be secured to the inner wall 110 using any suitable coupling. For example, in some embodiments, the plurality of tensioning members 160 may be coupled to the inner wall 110 via mechanical fasteners (e.g., clips, clamps, screws, snap-fit connectors, etc.), heat sealing, sewing, rivets, buttons, magnetic couplings, or any other similar suitable coupling without departing from the scope of the present disclosure.

It should be further appreciated that the specific number of the tensioning members 160 in the inflatable chamber 150 is not specifically limited in the embodiments of the present disclosure and can be adaptively adjusted according to the size of an actual product of the massage pool 10. For example, the number of the tensioning members 160 in the inflatable chamber 150 may be thirty-two, forty-eight, sixty-four, or any other number without departing from the scope of the present disclosure.

Referring again to FIGS. 1 and 2, in these embodiments, the inner wall 110 and the bottom wall 140 may jointly define the above water cavity 170, and the inflatable chamber 150 surrounds the water cavity 170 in a circumferential direction R of the water cavity 170.

Turning now to FIG. 3a, and in conjunction with FIGS. 1 and 2, the water inflow pipe 400 may include a first end 410 and a second end 420. The first end 410 of the water inflow pipe 400 may be located in the water cavity 170, the first end 410 of the water inflow pipe 400 may be connected to the water flow pipeline 300, the second end 420 of the water inflow pipe 400 may be located outside the outer wall 120, and the second end 420 of the water inflow pipe 400 may be connected to the water pump located outside the outer wall 120.

In these embodiments, the water pump may be capable of pumping the water flow to the water inflow pipe 400, the water flow may enter the water flow pipeline 300 through the water inflow pipe 400 and then enter the massage assembly 200 from the water flow pipeline 300, and the massage assembly 200 may spray the water flow into the water cavity 170.

In other embodiments, the massage pool 10 may be further provided with a water suction pipeline (not shown), which may be in communication with the water pump and the water cavity 170. In these embodiments, the water pump draws the water from the water cavity 170 by means of the water suction pipeline and pumps the drawn water into the water inflow pipe 400 to circulate the water flow. In some embodiments, a filter assembly may also be arranged in the water suction pipeline to filter the water flow during circulation.

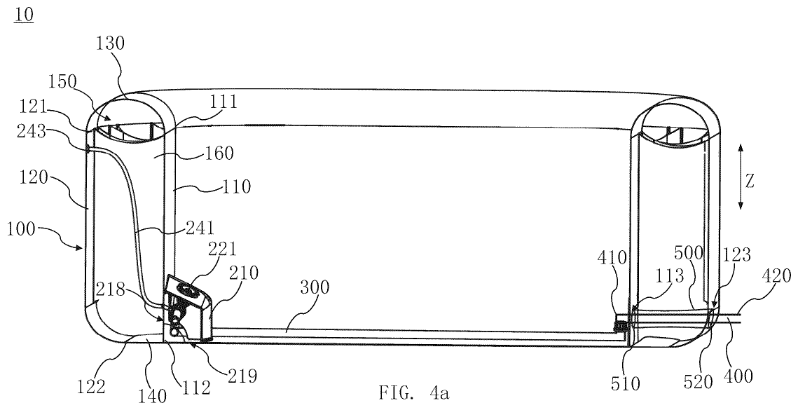

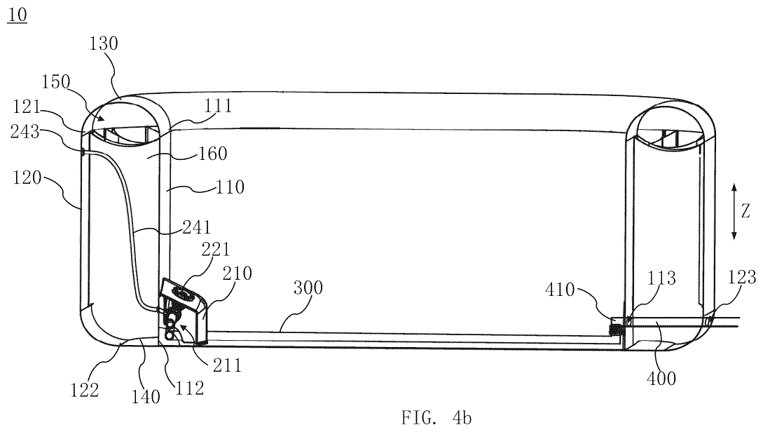

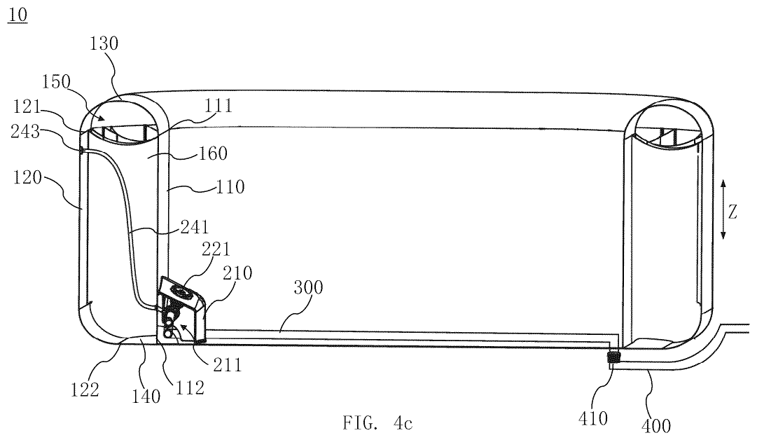

Turning now to FIG. 4a, a sleeve 500 may be further provided in the inflatable chamber 150, and the sleeve 500 may include a first end 510 and a second end 520. The inner wall 110 may be provided with a first opening 113, the outer wall 120 may be provided with a second opening 123, the sleeve 500 may be located between the first opening 113 and the second opening 123, the first end 510 of the sleeve 500 may be connected to the inner wall 110 by means of welding or adhesion, and the second end 520 of the sleeve 500 may be connected to the outer wall 120 by means of welding or adhesion.

In these embodiments, the first opening 113, the second opening 123 and the interior of the sleeve 500 may be in communication with each other. Thus, the water inflow pipe 400 passes through the sleeve 500 such that the first end 410 of the water inflow pipe 400 is located in the water cavity 170. As a result, the first end 410 of the water inflow pipe 400 may be connected to the water flow pipeline 300 located in the water cavity 170, and the water inflow pipe 400 may be in communication with the water flow pipeline 300. Also, the water inflow pipe 400 may be hermetically connected to the inner wall 110, the sleeve 500 and/or the outer wall 120 to avoid water leakage of the water cavity 170. In these embodiments, the sleeve 500 may be made of a soft non-breathable material to avoid air leakage of the inflatable chamber 150. For example, the sleeve 500 may be formed of a thermoplastic elastomer, polyvinyl chloride, silicone rubber, neoprene, rubber, nylon, polyester, polyurethane, or any other similar soft non-breathable material without departing from the scope of the present disclosure.

Turning now to FIG. 4b, in some embodiments, no sleeve may be arranged in the inflatable chamber 150, the water inflow pipe 400 may pass through the first opening 113 and may be connected to the inner wall 110 at the first opening 113 by means of welding or adhesion, and the water inflow pipe 400 may pass through the second opening 123 and may be connected to the outer wall 120 at the second opening 123 by means of welding or adhesion.

In these embodiments, the water inflow pipe 400 may enter the water cavity 170 without passing through the inflatable chamber 150. In other words, the inflatable chamber 150 may not include a part of the water inflow pipe 400. Specifically, referring to FIGS. 3b and 4c, the first end 410 of the water inflow pipe 400 may be located outside the outer wall 120, and a part of the water flow pipeline 300 may pass through the bottom wall 140 and may be hermetically connected to the bottom wall 140, such that the water flow pipeline 300 may be connected to the first end 410 of the water inflow pipe 400 located outside the bottom wall 140. Since the water flow pipeline 300 may be connected to the first end 410 of the water inflow pipe 400 outside the pool body 100 by means of the bottom wall 140 (e.g., the water flow pipeline 300 may be located outside the inflatable chamber 150), when water leakage occurs in the water flow pipeline 300, the user can also find the water leakage point in a timely manner, and it may be convenient to repair and replace the water flow pipeline 300.

In other embodiments, the first end 410 of the water inflow pipe 400 may also pass through the bottom wall 140 and be hermetically connected to the bottom wall 140. Thus, it should be appreciated that the first end of the water inflow pipe 400 may be located in the water cavity 170 and may be connected to the water flow pipeline 300.

In other embodiments still, the water pump may be provided in the inflatable chamber 150, and the first end 410 of the water inflow pipe 400 may pass through the inner wall 110 to be connected to the water flow pipeline 300 in the water cavity 170.

Referring now to FIG. 3a in some embodiments, the water flow pipeline 300 may be arranged approximate and/or adjacent to a joint of the inner wall 110 and the bottom wall 140 of the pool body 100, and the water flow pipeline 300 may extend in a circumferential direction of the inner wall 110 and may be in a substantially rectangular shape. However, it should be appreciated that the rectangular shape of the water flow pipeline 300 depicted in FIG. 3a is illustrative in nature, and the water flow pipeline 300 may take any shape without departing from the scope of the present disclosure. For example, when the pool body 100 is circular from the top view, the water flow pipeline 300 may also be circular due to the fact that the water flow pipeline 300 leans against the joint of the inner wall 110 and the bottom wall 140 of the pool body 100.

Referring still to FIG. 3a, in these embodiments, the water flow pipeline 300 may include two first water flow pipelines 310 (e.g., a first water flow pipeline 310a and a first water flow pipeline 310b) and two second water flow pipelines 320 (e.g., a second water flow pipeline 320a and a second water flow pipeline 320b). The first water flow pipeline 310 may include a first end 311 and a second end 312, and the second water flow pipeline 320 may include a first end 321 and a second end 322. Each first water flow pipeline 310 and each second water flow pipeline 320 may be formed in a substantially “L” shape, such that the two first water flow pipelines 310 and the two second water flow pipelines 320 may be connected end to end to form a substantially rectangular shape.

As further illustrated in FIG. 3a, the first end 311a of the first water flow pipeline 310a, the first end 311b of the first water flow pipeline 310b, and the first end 410 of the water inflow pipe 400 may be connected by means of a first tee pipe 600. In these embodiments, the first tee pipe 600 may include a first end 610, a second end 620 and a third end 630. The first end 610 of the first tee pipe 600 may be connected to the first end 410 of the water inflow pipe 400, the second end 620 of the first tee pipe 600 may be connected to the first end 311 of the first water flow pipeline 310a, and the third end 630 of the first tee pipe 600 may be connected to the first end 311 of the first water flow pipeline 310b.

In these embodiments, the second end 312 of the first water flow pipeline 310a (obscured by the massage assembly 200a in FIG. 3a) may be connected to the first end 321 of the second water flow pipeline 320a (obscured by the massage assembly 200a in FIG. 3a), and the second end 312 of the first water flow pipeline 310a and the first end 321 of the second water flow pipeline 320a may be connected to the massage assembly 200a. The second end 322a of the second water flow pipeline 320a may be connected to the first end 321b of the second water flow pipeline 320b, and the second end 322a of the second water flow pipeline 320a and the first end 321b of the second water flow pipeline 320b may be connected to the massage assembly 200b. The second end 322 of the second water flow pipeline 320b may be connected to the second end 312 of the first water flow pipeline 310b, and the second end 322 of the second water flow pipeline 320b and the second end 312 of the first water flow pipeline 310b may be connected to the massage assembly 200c. Thus, the water inflow pipe 400 may be in communication with the first water flow pipeline 310a, the first water flow pipeline 310b, the second water flow pipeline 320a and the second water flow pipeline 320b.

In operation, when the user needs massage, the water pump located outside the pool body 100 pumps the water flow into the water flow pipeline 300 by means of the water inflow pipe 400, delivers part of the water flow to the massage assembly 200a by means of the first water flow pipeline 310a, delivers part of the water flow to the massage assembly 200b by means of the second water flow pipeline 320a, delivers part of the water flow to the massage assembly 200c by means of the first water flow pipeline 310b, and delivers part of the water flow to the massage assembly 200b by means of the second water flow pipeline 320b, such that each of the massage assemblies 200 (e.g., the massage assembly 200a, the massage assembly 200b and the massage assembly 200c) spray the water flow into the water cavity 170 for massage.

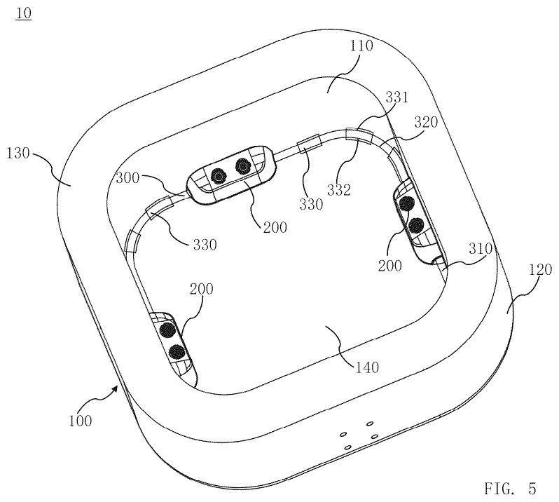

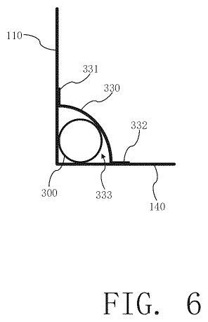

Referring now to FIGS. 5 and 6, in some embodiments, the joint of the inner wall 110 and the bottom wall 140 may confine the water flow pipeline 300 by means of a plurality of fixing pieces 330. For example, the plurality of fixing pieces 330 may be located in the water cavity 170, and each first water flow pipeline 310 may be secured between the joint of the inner wall 110 and the bottom wall 140 by means of the plurality of fixing pieces 330. Each second water flow pipeline 320 may be similarly secured between the inner wall 110 and the bottom wall 140 by means of the plurality of fixing pieces 330. In these embodiments, each of the plurality of fixing pieces 330 may be made of a soft material, but may be not limited thereto. For example, in other embodiments, the plurality of fixing pieces 330 may also be made of a hard material. When the fixing piece 330 may be made of the hard material, an edge thereof may be coated with an elastic material and may be connected to the inner wall 110 or the bottom wall 140 by means of the elastic material at the edge.

It should be further appreciated that the massage pool 10 may include any number of the plurality of fixing pieces 330, so long as the number of the plurality of fixing pieces 330 is sufficient to confine the water flow pipeline 300 to the joint of the inner wall 110 and the bottom wall 140. For example, in some embodiments, the first water flow pipeline 310 may be limited to the joint of the inner wall 110 and the bottom wall 140 by means of one, two, three, four or more fixing pieces 330, and the second water flow pipeline 320 may be limited to the joint of the inner wall 110 and the bottom wall 140 by means of one, two, three, four or more fixing pieces 330. However, the plurality of fixing pieces 330 may include any number of pieces without departing from the scope of the present disclosure.

As illustrated most clearly in FIG. 5 each fixing piece 330 may include a first connecting edge 331 and a second connecting edge 332, and the first connecting edge 331 and the second connecting edge 332 may be located on two opposite sides of the fixing piece 330 respectively. The first connecting edge 331 of each fixing piece 330 may be connected to the inner wall 110 by means of welding or adhesion, and the second connecting edge 332 of each fixing piece 330 may be connected to the bottom wall 140 by means of welding or adhesion. In other embodiments, the first connecting edge 331 may also be detachably connected to the inner wall 110 by means of a hook and loop fastener, or any other similarly detachable fastener, and the second connecting edge 332 may also be detachably connected to the bottom wall 140 by means of a hook and loop fastener, or any other similarly detachable fastener to facilitate removal of the fixing pieces 330 and the repair and replacement of the water flow pipeline 300 by the user.

Referring again to FIGS. 5 and 6, in these embodiments, the fixing pieces 330, the inner wall 110 and the bottom wall 140 may jointly define a fixing space 333, and the fixing space 333 may accommodate at least a part of the water flow pipeline 300 to limit the water flow pipeline 300. In other words, the water flow pipeline 300 passes through the fixing space 333, so that the fixing pieces 330 limit the water flow pipeline 300 to the inner wall 110 and the bottom wall 140. In the embodiments described herein, it should be understood that the term “limit” refers to a mechanical and/or spatial constraint on the water flow pipeline 300 that limits the position and movement of the water flow pipeline 300 to within the fixing space 333.

Turning now to FIG. 2, when the user 20 uses the massage pool 10 and leans against the inner wall 110 of the pool body 100, the shoulder of the user 20 generally abuts against the upper wall 130 or the inner wall 110 of the pool body 100, the waist and back of the user and the height direction Z generally form an included angle (as shown in FIG. 2), and thus the buttocks of the user 20 are spaced from the inner wall 110 in the horizontal direction X. Accordingly, the body of the user 20 may not be in contact with the water flow pipeline 300 at the joint of the inner wall 110 and the bottom wall 140. To that extent, the water flow pipeline 300 may be limited to the joint of the inner wall 110 and the bottom wall 140, such that the water flow pipeline 300 does not bring a foreign matter sensation to the user 20 and does not affect the use experience of the user 20. It should be further appreciated that the length of the fixing piece 330 may not be specifically limited in the embodiment of the present disclosure.

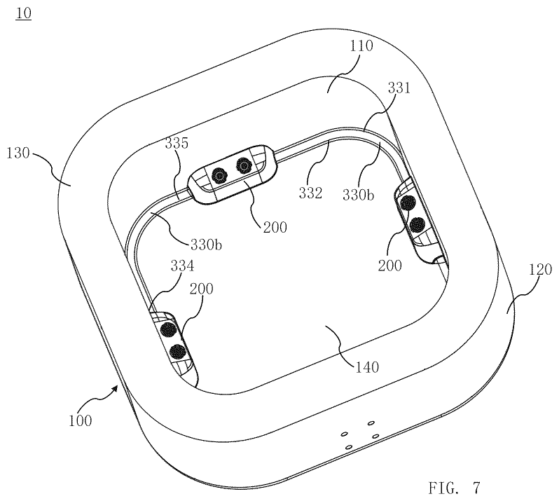

Referring now to FIG. 7, in some embodiments, the fixing piece 330b for limiting the second water flow pipeline 320 is depicted in additional detail In the embodiment shown in FIG. 7, the fixing piece 330b may further include a first end 334 and a second end 335, where the first end 334 of the fixing piece 330b extends to one massage assembly 200 of the massage assemblies 200 located at two ends of the second water flow pipeline 320, and the second end 335 of the fixing piece 330b extends to the other massage assembly 200 of the massage assemblies 200 located at the two ends of the second water flow pipeline 320. In these embodiments, the fixing space 333 defined by the fixing piece 330b and the inner wall 110 and the bottom wall 140 may accommodate a part of the second water flow pipeline 320 located between two adjacent massage assemblies 200.

Accordingly, in the embodiment depicted in FIG. 7, the length of the fixing piece 330b may be the same as the length of the second water flow pipeline 320 located between the two adjacent massage assemblies 200 to cover the part of the second water flow pipeline 320 located between the two adjacent massage assemblies 200, so that the second water flow pipeline 320 can be prevented from being exposed to the water cavity 170. Thus, the fixing piece 330b may improve the aesthetic appearance of the massage pool 10 while the second water flow pipeline 320 may be limited to the joint of the inner wall 110 and the bottom wall 140.

Referring again to FIG. 3a, in these embodiments, the first end 334 of the fixing piece 330b may extend to the first end 311 of the first water flow pipeline 310, and the second end 335 of the fixing piece 330b may extend to the massage assembly 200, such that the fixing space 333 defined by the fixing piece 330b, the inner wall 110 and the bottom wall 140 accommodates a part of the first water flow pipeline 310 located between the water inflow pipe 400 and the massage assembly 200. Accordingly, in these embodiments the fixing piece 330b may cover a part of the first water flow pipeline 310 located between the water inflow pipe 400 and the massage assembly 200 to prevent the first water flow pipeline 310 from being exposed to the water cavity 170. Thus, the fixing piece 330b may improve the aesthetic appearance of the massage pool 10 while the first water flow pipeline 310 may be limited to the joint of the inner wall 110 and the bottom wall 140.

It should be noted that the position of the first end 334 or the second end 335 of the fixing piece 330b is not specifically limited in the embodiments of the present disclosure. For example, in some embodiments, the first end 334 or the second end 335 of the fixing piece 330b may extend into the massage assembly 200 or may extend to be proximate and/or adjacent to the massage assembly 200, as long as the fixing piece 330b covers the part of the first water flow pipeline 310 located between the water inflow pipe 400 and the massage assembly 200, and the fixing piece 330b covers the part of the second water flow pipeline 320 located between the two adjacent massage assemblies 200, so as to prevent the water flow pipeline 300 from being exposed to the water cavity 170.

With reference now to FIG. 4a, the massage assembly 200 may be arranged proximate and/or adjacent to the inner wall 110 and the bottom wall 140, where the water flow pipeline 300 may be configured to provide the water flow to the massage assembly 200, and the massage assembly 200 sprays the water flow into the water cavity 170.

It should be further appreciated that the specific position of the massage assembly 200 may not be limited to the embodiments of the present disclosure. For example, the massage assembly 200 may also be provided above the bottom wall 140 in the height direction Z and may be spaced from the bottom wall 140.

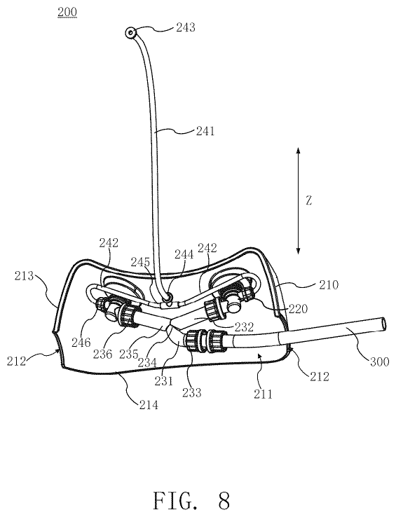

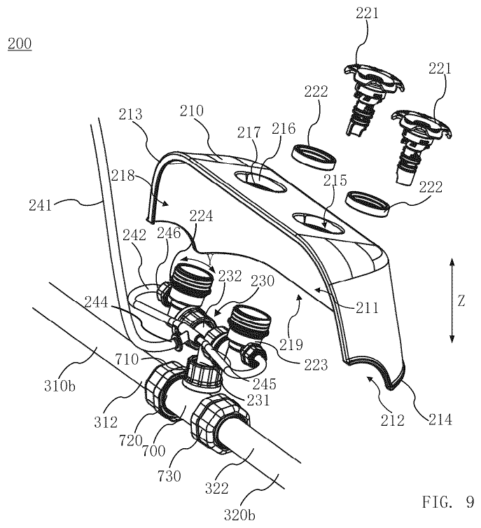

Turning now to FIGS. 8 and 9, in some embodiments, the massage assembly 200 may further include a shell 210, two spray head assemblies 220 and a connecting pipe 230.

In these embodiments, the shell 210 may be located in the water cavity 170, and the shell 210 may include a first side opening 218 and a second side opening 219. The first side opening 218 may have a first edge 213 surrounding a part of the first side opening 218, the second side opening 219 may have a second edge 214 surrounding a part of the second side opening 219, and the interior of the shell 210 may be hollow. With reference to FIG. 9 and in conjunction with FIG. 4a, the first side opening 218 of the shell 210 may face the inner wall 110, the first edge 213 may abut the inner wall 110, the second side opening 219 may face the bottom wall 140, and the second edge 214 may abut the bottom wall 140. Thus, the inner wall 110, the bottom wall 140 and the shell 210 may jointly define an accommodating space 211. In these embodiments, both the first edge 213 and the second edge 214 are coated with an elastic plastic, so that the shell 210 can be prevented from scratching the inner wall 110 or the bottom wall 140 of the pool body 100. Moreover, in the embodiments described herein, the shell 210 may abut the inner wall 110 and the bottom wall 140, such that the shell 210 may be conveniently removed to repair or replace the components inside the massage assembly 200.

It should be noted that a connecting method of the shell 210 and the inner wall 110 and the bottom wall 140 is not limited to the embodiments depicted in the present disclosure. For example, in some embodiments, the first edge 213 of the shell 210 may be connected to the inner wall 110 by means of, welding or adhesion, and the second edge 214 may be connected to the bottom wall 140 by means of welding or adhesion. However, it should be further appreciated that the shell 210 may be coupled to the inner wall 110 by means of any suitable coupling without departing from the scope of the present disclosure.

Referring again to FIGS. 8 and 9, a part of each spray head assembly 220 of the two spray head assemblies 220 may be located in the accommodating space 211, the other part may be located outside the shell 210, the connecting pipe 230 may be provided in the accommodating space 211, and the water flow pipeline 300 may be connected to the spray head assembly 220 by means of the connecting pipe 230, such that the water flow pipeline 300 delivers the water flow to the spray head assembly 220 of the massage assembly 200. In these embodiments, one end of an air pipe 240 may be in communication with outside air, the other end may be connected to the connecting pipe 230, the outside air flows into the connecting pipe 230 through the air pipe 240, the outside air may be mixed with the water flow in the connecting pipe 230 to form a water-air mixed fluid, and the spray head assembly 220 sprays the water-air mixed fluid into the water cavity 170 for massage, so that the comfort of the massage can be effectively improved, and better experience can be brought to the user.

As noted hereinabove, it should be understood that the massage pool 10 may include any number of the plurality of spray head assemblies 220 without departing from the scope of the present disclosure. For example, in some embodiments, the massage assembly 200 may include one, two, three, four, five, or any other number of spay head assemblies 220 as may be required to provide a desired massage experience to the user.

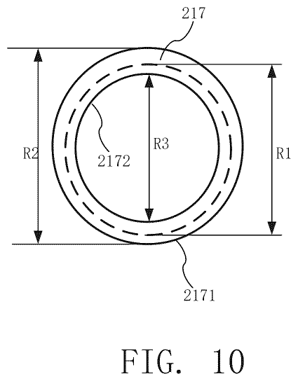

Referring still to FIGS. 8 and 9, in the height direction Z, the top of the shell 210 may be provided with two connecting holes 215, an inner side piece 217 may be provided in each connecting hole 215, one spray head assembly 220 may be located in one connecting hole 215, and the spray head assembly 220 may be connected to the inner side piece 217 in the connecting hole 215. With reference to FIG. 10, the inner side piece 217 may be an annular sheet material, and the inner side piece 217 includes an outer edge 2171 and an inner edge 2172. The outer edge 2171 of the inner side piece 217 may be integrally formed with a hole wall 216 of the connecting hole 215. Although the outer edge 2171 is described herein as being integrally formed with the hole wall 216, it should be appreciated that, in other embodiments, the outer edge 2171 may be connected to the hole wall 216 of the connecting hole 215 by means of welding, adhesion, or any other similar coupling without departing from the scope of the present disclosure.

Referring still to FIGS. 8 and 9, in these embodiments, each spray head assembly 220 may include a spray head 221, a fixing member 222 and a connecting portion 223. The connecting portion 223 may be connected to the water flow pipeline 300 by means of the connecting pipe 230, such that the water flow pipeline 300 delivers the water flow to the spray head assembly 220.

An outer side of the connecting portion 223 may include a flange 224, and the flange 224 may be arranged around the connecting portion 223 in a circumferential direction Y of the connecting portion 223.

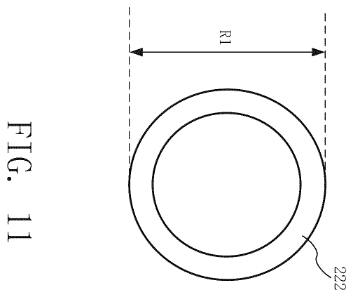

Turning now to FIGS. 8-11, in these embodiments, the fixing member 222 may be of an annular structure, the outer diameter R1 of the fixing member 222 may be less than the outer diameter R2 of the inner side piece, and the outer diameter R1 of the fixing member 222 may be greater than the inner diameter R3 of the inner side piece 217. With continued reference to FIGS. 8 and 9, the connecting portion 223 may be located in the accommodating space 211, and the fixing member 222 may be provided in the connecting hole 215.

The fixing member 222 may be detachably connected to the connecting portion 223. Specifically, the connecting portion 223 may be provided with an external thread, the fixing member 222 may be provided with an internal thread, and the fixing member 222 and the connecting portion 223 are threadedly connected. Furthermore, a part of the inner side piece 217 may be located between the flange 224 of the connecting portion 223 and the fixing member 222. That may be to say, the inner side piece 217 may be clamped between the fixing member 222 and the flange 224 of the connecting portion 223 while the fixing member 222 and the connecting portion 223 are threadedly connected, and in this case, the fixing member 222 may be equivalent to a nut, and the fixing member 222 fixes the inner side piece 217 to the connecting portion 223. Accordingly, it should be understood that the fixing member 222 and the connecting portion 223 are limited in the connecting hole 215 by means of the inner side piece 217. However, the connecting method of the fixing member 222 and the connecting portion 223 described herein is for illustrative purposes, and the fixing member 222 and the connecting portion 223 may be otherwise connected without departing from the scope of the present disclosure. For example, in other embodiments the fixing member 222 and the connecting portion 223 can also be detachably connected in a snap-fit manner.

Referring again to FIGS. 8 and 9, a part of the spray head 221 may be located in the accommodating space 211. For example, one end of the spray head 221 may be located outside the shell 210, and the other end may be located inside the connecting portion 223. The connecting portion 223 may be internally provided with a snap-fit structure (not shown), the snap-fit structure may be snap-fitted with the other end of the spray head 221 to detachably connect the spray head 221 to the connecting portion, so that the spray head 221 may be conveniently removed to repair or replace the spray head 221 by the user. However, it should be appreciated that the snap-fit structure described herein is exemplary in nature, and the connecting portion 223 may have any suitable snap-fit structure without departing from the scope of the present disclosure. For example, in some embodiments, the snap-fit structure may be a rotary snap-fit structure, and when the spray head 221 is mounted to the connecting portion 223, the other end of the spray head 221 may penetrate the fixing member 222 through the connecting hole 215 and extend into the connecting portion 223, and the other end of the spray head 221 may be snap-fitted to the snap-fit structure by turning the spray head 221.

It should be further appreciated that, in the embodiments described herein, each shell 210 may have any number of connecting holes 215 without departing from the scope of the present disclosure, and the number of the connecting holes 215 may correspond to the number of the spray head assemblies 220 on a one-to-one basis (e.g., such that the number of connecting holes 215 is equal to the number of spray head assemblies). For example, in some embodiments, the number of spray head assemblies 220 in each massage assembly 200 may also be one, three, four or any other number without departing from the scope of the present disclosure.

With continued reference to FIG. 9, in the embodiment of the present disclosure, the connecting portions 223 of the two spray head assemblies 220 may be connected to the water flow pipeline 300 by means of one connecting pipe 230 and one second tee pipe 700. In particular, the connecting pipe 230 may include a main water pipe 231 and two branch water pipes 232, where the main water pipe 231 includes a first end 233 and a second end 234, and each branch water pipe 232 of the two branch water pipes 232 includes a first end 235 and a second end 236.

Referring still to FIGS. 8 and 9, the first end 233 of the main water pipe 231 of the connecting pipe 230 may be connected to the water flow pipeline 300, the second end 234 of the main water pipe 231 may be connected to the first end 235 of each of the two branch water pipes 232, and the second end 236 of each branch water pipe 232 of the two branch water pipes 232 may be connected to the connecting portion 223 of one spray head assembly 220.

It should be appreciated that the branch water pipes 232 in each connecting pipe 230 may include any number of branch water pipes 232 without departing from the scope of the present disclosure. Moreover, the number of the branch water pipes 232 may correspond to the number of the spray head assemblies 220 on a one-to-one basis (e.g., such that the number of branch water pipes 232 is equal to the number of the spray head assemblies). For example, in other possible implementations, the number of the branch water pipes 232 of one connecting pipe 230 may be three, four, five or any other number without departing from the scope of the present disclosure.

In the embodiments described herein, it should be further understood that the connecting pipe 230 may be a hose. For example, the main water pipe 231 and the branch water pipe 232 may be hoses, but are not limited thereto. In other embodiments, the connecting pipe 230 may also be a rigid pipe, such that the main water pipe 231 and the branch water pipe 232 are both rigid pipes. In some other embodiments, one or two of the main water pipe 231 and the two branch water pipes 232 may be hoses, and the remaining pipe(s) may be a rigid pipe(s). That is to say, a part of the connecting pipe 230 may be a rigid pipe, and the other part may be a hose.

With reference to FIG. 9 and in conjunction with FIG. 3a, the massage assembly 200c may be connected to the first water flow pipeline 310b and the second water flow pipeline 320b respectively. In these embodiments, the connecting pipe 230 may be connected to the first water flow pipeline 310b and the second water flow pipeline 320b by means of the second tee pipe 700. The second tee pipe 700 may include a first end 710, a second end 720 and a third end 730. The first end 710 of the second tee pipe 700 may be connected to the first end 233 of the main water pipe 231, the second end 720 of the second tee pipe 700 may be connected to the second end 312 of the first water flow pipeline 310b, and the third end 730 of the second tee pipe 700 may be connected to the second end 322 of the second water flow pipeline 320b.

Accordingly, it should be appreciated that the connecting portion 223 of each spray head assembly 220 may be in communication with one branch water pipe 232 and the main water pipe 231 of the connecting pipe 230 and the water flow pipeline 300, such that the water flow pipeline 300 delivers the water flow to the connecting portion 223 of the spray head assembly 220 by means of the main water pipe 231 and the branch water pipe 232.

It should be noted that the connecting method of the connecting pipe 230 and the water flow pipeline 300 described herein is exemplary in nature, and the connecting pipe 230 and water flow pipeline 300 may be coupled via any suitable connecting method without departing from the scope of the present disclosure For example, when one massage assembly 200 is connected only to one first water flow pipeline 310 or one second water flow pipeline 320, the main water pipe 231 of the connecting pipe 230 may be directly connected to the second end 312 of the first water flow pipeline 310, or the first end 321 of the second water flow pipeline 320, or the second end 322 of the second water flow pipeline 320.

With continued reference to FIGS. 8 and 9 and in conjunction with FIG. 3a, the air pipe 240 may include a main air pipe 241 and two branch air pipes 242. The main air pipe 241 may include a first end 243 and a second end 244. Each branch air pipe 242 of the two branch air pipes 242 may include a first end 245 and a second end 246.

In these embodiments, the first end 243 of the main air pipe 241 may be connected to the outer wall 120 of the pool body 100 by means of, for example, welding or adhesion, and may be in communication with the outside to allow the communication between the main air pipe 241 and the outside air. The first end 245 of each branch air pipe 242 of the two branch air pipes 242 may be connected to the second end 244 of the main air pipe 241, and the second end 246 of each branch air pipe 242 of the two branch air pipes 242 may be connected to the connecting portion 223 of one spray head assembly 220. Thus, the connecting portion 223 of each spray head assembly 220 may be in communication with the outside air through one branch air pipe 242 and the main air pipe 241 to allow the outside air to enter the connecting portion 223 of one spray head assembly 220 through the main air pipe 241 and the one branch air pipe 242 in sequence. Furthermore, the outside air may be mixed, in the connecting portion 223, with the water flow delivered from the water flow pipeline 300 to the connecting portion 223 to form a water-air mixed fluid; and the spray head 221 sprays the water-air mixed fluid into the water cavity 170 to massage the user, thereby bringing better experience to the user.

As described hereinabove, the air pipe 240 may be a hose, such that both the main air pipe 241 and the two branch air pipes 242 are hoses. In other embodiments, the air pipe 240 may be a rigid pipe, that is to say, the main air pipe 241 and the two branch air pipes 242 are rigid pipes. In some other possible implementations, one or two of the main air pipe 241 and the two branch air pipes 242 may be rigid pipes, and the remaining pipe(s) may be a hose(s). Accordingly, a part of the air pipe 240 may be a rigid pipe, and the other part may be a hose.

It should be further appreciated that the brain air pipes 242 may include any number of branch air pipes without departing from the scope of the present embodiment. However, in the embodiments described herein, the number of the branch air pipes 242 in each air pipe 240 may correspond to the number of the spray head assemblies 220 in each massage assembly 200 on a one-to-one basis (e.g., such that the number of the air branch pipes 242 is equal to the number of spray head assemblies). For example, in some embodiments, the number of the branch air pipes 242 in each air pipe 240 may also be three, four, five or any other number without departing from the scope of the present disclosure

It should be further understood that the position of the first end 243 of the main air pipe 241 described herein exemplary in nature, and the first end 243 of the main air pipe 241 may have any position as long as the main air pipe 241 may be in communication with the outside air. For example, in other embodiments, the first end 243 of the main air pipe 241 may also be connected to the upper wall 130 of the pool body 100 by means of, for example, welding or adhesion.

In some embodiments, one spray head assembly 220 may be provided in the massage assembly 200. Accordingly, the connecting pipe 230 and the air pipe 240 may both be straight pipes. That is to say, the connecting pipe 230 may not include the above branch water pipe 232, and the air pipe 240 may not include the above branch air pipe 242. In particular, one end of the connecting pipe 230 may be connected to the water flow pipeline 300, and the other end of the connecting pipe 230 may be connected to the connecting portion 223. One end of the air pipe 240 may be connected to the outer wall 120, and the other end of the air pipe 240 may be connected to the connecting portion 223.

It should be noted that the massage pool 10 may be provided with only one first water flow pipeline 310. For example, in some embodiments, the massage pool 10 may not be provided with the first water flow pipeline 310b. Accordingly, the connecting pipe 230 of the massage assembly 200c may be directly connected to the second end 322 of the second water flow pipeline 320b, without connecting to the second end 322 of the second water flow pipeline 320b by means of the second tee pipe 700.

To this end, the present disclosure discloses a solution in which the water flow pipeline of the massage pool may be arranged in the water cavity, and when water leakage occurs in the water flow pipeline, the user can find the water leakage point in a timely manner, thereby enabling the user to more conveniently perform repairs and replacements.

Although the present disclosure has been illustrated and described with reference to some preferred implementations of the present disclosure, those of ordinary skill in the art should understand that the above contents are further detailed descriptions for the present disclosure with reference to specific implementations, and it cannot be assumed that the specific implementations of the present disclosure are limited to these descriptions. Those skilled in the art can make various changes in form and details, including several simple deduction or substitutions, without departing from the spirit and scope of the present disclosure.

The foregoing descriptions are only embodiments of the present disclosure and are not intended to limit the present disclosure. For those skilled in the art, various changes and variations can be made to the present disclosure. Any modifications, equivalent replacements, and improvements made without departing from the spirit and principle of the present disclosure shall fall within the scope of the claims of the present disclosure.

Furthermore, it should be apparent that the present disclosure is not limited to the details of the above-mentioned exemplary embodiments, and the present disclosure can be implemented in other specific forms without departing from the spirit or basic features of the present disclosure. Therefore, no matter from which point of view, the embodiments should all be regarded as exemplary and non-limiting. The scope of the present disclosure is defined by the appended claims rather than the above-mentioned description, and therefore it is intended that all changes which fall within the meaning and range of equivalents of the claims are embraced in the present disclosure. Any reference signs in the claims should not be construed as limiting the claims involved. In addition, it is apparent that the word “comprise/include” does not exclude other elements or steps, and the singular does not exclude the plural. The terms first, second, etc. are used for designations and do not represent any particular order.

It should be understood that the embodiments as shown in the drawings only show the optional shapes, sizes and arrangements of optional components of the air valve and inflatable products according to the present disclosure, which are merely illustrative but not restrictive, and other shapes, sizes and arrangements may be employed without departing from the idea and scope of the present disclosure.

The technical contents and technical features of the present disclosure are disclosed above, but it can be understood that those skilled in the art would have made various variations and improvements to the concepts disclosed above under the creative idea of the present disclosure, and all the variations and improvements fall into the scope of protection of the present disclosure. The descriptions of the above embodiments are illustrative but not restrictive, and the scope of protection of the present disclosure is determined by the claims.

1. A massage pool comprising:
an inner wall comprising a top end and a bottom end;
an outer wall surrounding the inner wall and comprising a top end and a bottom end;
an upper wall connected to the top end of the inner wall and the top end of the outer wall;
a bottom wall connected to the bottom end of the inner wall and the bottom end of the outer wall;
a water cavity defined by the inner wall and the bottom wall;
a massage assembly provided in the water cavity and configured to spray a water flow into the water cavity, the massage assembly comprising:
a shell located in the water cavity and defining an accommodating space together with the inner wall;
a spray head assembly at least partially located in the accommodating space and detachably connected to the shell;
a water flow pipeline connected to the spray head assembly and configured to provide a water flow to the spray head assembly; and
a water pump located outside the water cavity and connected to the water flow pipeline.

2. The massage pool of claim 1, wherein the spray head assembly comprises:
a connecting portion in fluid communication with the water flow pipeline;
a spray head at least partially located in the accommodating space and in fluid communication with the connecting portion; and
a fixing member detachably connected to the connecting portion and clamping the shell together with the connecting portion.

3. The massage pool of claim 2, wherein the shell comprises:
a connecting hole accommodating at least part of the fixing member; and
an inner side piece located in the connecting hole and connected to a hole wall of the connecting hole, the connecting portion and the fixing member clamping the inner side piece.

4. The massage pool of claim 3, wherein the shell is located at a joint of the inner wall and the bottom wall, and the connecting hole of the shell is located in a top surface of the shell.

5. The massage pool of claim 4, wherein an edge of the shell facing at least one of the inner wall or the bottom wall is coated with an elastic plastic.

6. The massage pool of claim 2, further comprising an air pipe, the air pipe comprising:
a first end connected to the outer wall or the upper wall and in communication with an external environment; and
a second end in fluid communication with the connecting portion.

7. The massage pool of claim 1, wherein the water flow pipeline is located in the water cavity.

8. The massage pool of claim 7, wherein the water pump is connected to the water flow pipeline by means of a water inflow pipe, the water inflow pipe comprising:
a first end connected to the water flow pipeline; and
a second end connected to the water pump.

9. The massage pool of claim 8, wherein the water pump is provided outside the outer wall; the inner wall comprises a first opening, the water inflow pipe passing through the first opening and being connected to the inner wall at the first opening; and the outer wall comprises a second opening, the water inflow pipe passing through the second opening and being connected to the inner wall at the second opening.

10. The massage pool of claim 8, wherein the water pump is provided outside the outer wall; the inner wall comprises a first opening, the outer wall comprises a second opening, and a sleeve is arranged between the first opening and the second opening, the sleeve comprising:
a first end connected to the inner wall; and
a second end connected to the outer wall;
wherein the water inflow pipe passes through the sleeve and is hermetically connected to the inner wall, the sleeve or the outer wall.

11. The massage pool of claim 8, wherein the water pump is provided outside the outer wall; and the water inflow pipe or the water flow pipeline passes through the bottom wall and is hermetically connected to the bottom wall.

12. The massage pool of claim 7, further comprising:
a fixing piece located in the water cavity, the fixing piece comprising:
a first connecting edge connected to the bottom wall;
a second connecting edge arranged opposite to the first connecting edge, and connected to the inner wall; and
a fixing space defined by the fixing piece and the inner wall, the fixing space accommodating at least a part of the water flow pipeline.

13. The massage pool of claim 12, wherein the fixing piece further comprises a first end and a second end;
the first end of the fixing piece extends to one of two adjacent massage assemblies, and the second end of the fixing piece extends to the other of the two adjacent massage assemblies; or
the first end of the fixing piece extends to one of the massage assemblies, and the second end of the fixing piece extends to a water inflow pipe.

14. The massage pool of claim 1, further comprising:
an inflatable chamber jointly defined by the inner wall, the outer wall, the upper wall and the bottom wall, and surrounding the water cavity; and
a plurality of tensioning members provided in the inflatable chamber, one end of each of the plurality of tensioning members being connected to the inner wall, and the other end being connected to the outer wall.

15. A massage pool comprising:
an inflatable chamber defined by an inner wall, an outer wall, an upper wall, and a bottom wall;
a water cavity defined by the inner wall and the outer wall of the inflatable chamber;
a water pump arranged outside the inflatable chamber;
a massage assembly provided within the water cavity;
a water flow pipeline connected to the massage assembly and configured to deliver water to the massage assembly;
a water inflow pipe connected between the water pump and the water flow pipeline;
wherein the water inflow pipe passes through the bottom wall and is hermetically sealed to the bottom wall, such that at least a portion of the water inflow pipe is arranged outside the inflatable chamber.

16. The massage pool of claim 15, wherein the water flow pipeline extends along a joint formed between the inner wall and the bottom wall.

17. The massage pool of claim 15, wherein the water flow pipeline is fixed in position by at least one fixing piece arranged in the water cavity.

18. The massage pool of claim 17, wherein the at least one fixing piece further comprises:
a first connecting edge coupled to the inner wall;
a second connecting edge coupled to the bottom wall; and
a fixing space defined between the fixing piece, the inner wall, and the outer wall, the fixing space being configured to accommodate the water flow pipeline.

19. A massage pool comprising:
an inflatable chamber defined by an inner wall, an outer wall, an upper wall, and a bottom wall;
a water cavity defined by the inner wall and the outer wall of the inflatable chamber;
a massage assembly provided within the water cavity, the massage assembly comprising:
a shell defining an accommodating space;
a spray head assembly including a spray head and a connecting portion, the connecting portion being detachably connected to the shell and the spray head being detachably connected to the connecting portion; and
a water flow pipeline connected to the connection portion and configured to deliver water to the spray head; and
at least one fixing piece comprising a first connecting edge connected to the inner wall and a second connecting edge connected to the outer wall, the fixing piece defining a fixing space that receives at least a portion of the water flow pipeline;
wherein the at least one fixing piece is detachably mounted to the inner wall and the bottom wall.

20. The massage pool of claim 19, wherein the spray head is detachably connected to the connecting portion using a snap-fit interface.
